(19) United States
(12) Patent Application Publication
(10) Pub. No.: US 2013/0033631 A1
(43) Pub. Date: Feb. 7, 2013

(54) SOLID-STATE IMAGING DEVICE AND IMAGING DEVICE

(71) Applicant: Keiji Mabuchi, Kanagawa (JP)

(72) Inventor: Keiji Mabuchi, Kanagawa (JP)

(73) Assignee: Sony Corporation, Tokyo (JP)

(21) Appl. No.: 13/533,380

(22) Filed: Jun. 26, 2012

(30) Foreign Application Priority Data
Aug. 1, 2011 (JP) 2011-168020

(51) Int. Cl. H04N 5/335

(52) U.S. Cl. 348/302; 348/E05.091

(57) ABSTRACT

There is provided a solid-state imaging device including pixels configured to convert an electromagnetic wave into charge and output a signal corresponding a charge amount; and a pixel unit in which the pixels are two-dimensionally arranged, and a configuration of a part for converting the electromagnetic wave into the charge is the same in adjacent pixels, but a relation between the charge amount and a signal amount is allowed to differ between the adjacent pixels.

### BACKGROUND

The present technology relates to a solid-state imaging device and an imaging device provided with the solid-state imaging device.

As a method of expanding the dynamic range for a CMOS image sensor (a CMOS type solid-state imaging device), various methods are known.

For example, a method that provides a difference in sensitivity between adjacent pixels to expand the dynamic range has been proposed.

As a method of providing a difference in sensitivity between adjacent pixels to expand the dynamic range as described above, the following methods are known (for example, refer to Japanese Unexamined Patent Application Publication No. 2005-332880).

According to a first method, the use efficiency of light is changed by allowing an aperture ratio or transmittance to differ between the adjacent pixels, so that the difference is provided in the sensitivity.

According to a second method, a storage time is allowed to differ between the adjacent pixels, so that the difference is provided in the sensitivity.

### SUMMARY

However, the above-mentioned two methods have the following problems.

According to the first method, when two types of sensitivity are employed, the number of actual pixels is reduced to ½, resulting in a reduction of resolution. Furthermore, as with the case in which a difference in brightness of an object is small, even when it is not necessary to expand the dynamic range, resolution may be reduced. In addition, in a pixel with low aperture ratio or transmittance, loss before light is incident on the pixel is large, resulting in a significant reduction of charge obtained when an object is dark.

According to the second method, when shake occurs or an object includes a moving object, color shift and the like occur in an edge.

In light of the foregoing, it is desirable to provide a solid-state imaging device and an imaging device provided with the solid-state imaging device, capable of expanding a dynamic range without color shift.

A solid-state imaging device of the present technology includes pixels configured to convert an electromagnetic wave into charge and output a signal corresponding to a charge amount. Furthermore, the solid-state imaging device includes a pixel unit in which the pixels are two-dimensionally arranged, a configuration of a part for converting the electromagnetic wave into the charge is the same in adjacent pixels, but a relation between the charge amount and a signal amount is allowed to differ between the adjacent pixels.

An imaging device of the present technology includes the solid-state imaging device of the present technology, an optical unit configured to guide incident light to the solid-state imaging device, and a signal processing circuit configured to process an output signal of the solid-state imaging device.

According to the configuration of the above-mentioned solid-state imaging device of the present technology, the part for converting the electromagnetic wave into the charge is the same in the adjacent pixels, but it is possible to allow the relation between the charge amount and the signal amount to differ.

It is possible to allow the relation (that is, a conversion gain) between the charge amount and the signal amount to differ in the adjacent pixels, so that it is possible to obtain a signal with high conversion gain and high sensitivity and a signal with low conversion gain and low sensitivity from the adjacent pixels. Consequently, it is possible to expand a dynamic range.

Meanwhile, since the configuration of the part for converting the electromagnetic wave into the charge is the same in the adjacent pixels, a charge storage time is the same in the adjacent pixels. Consequently, even when there is shake or the movement of an object, it is possible to prevent the occurrence of color shift. Moreover, since charge obtained in a pixel with a low conversion gain is the same as in a pixel with a high conversion gain, a sufficient amount of charge is obtained.

Since the configuration of the above-mentioned imaging device of the present technology includes the solid-state imaging device of the present technology, it is possible to expand the dynamic range without color shift in the solid-state imaging device.

According to the above-mentioned present technology, it is possible to expand the dynamic range without color shift, resulting in an increase in the dynamic range and in the achievement of a solid-state imaging device or an imaging device capable of obtaining a high quality image.

Furthermore, according to the present technology, it is not necessary to read a signal from the same pixel twice, a solid-state imaging device with a complicated configuration is not necessary, and it is possible to expand the dynamic range using a low cost configuration.

### BRIEF DESCRIPTION OF THE DRAWINGS

FIG. 1 is a schematic configuration diagram (a block diagram) of a solid-state imaging device according to a first embodiment;

FIG. 2 is a circuit configuration diagram of a pixel of a pixel unit of FIG. 1;

FIG. 3 is a timing chart of a driving pulse for driving the pixel of FIG. 2;

FIG. 4 is a schematic configuration diagram of a wire connected to each pixel of FIG. 1;

FIG. 5 is a circuit configuration diagram of a pixel of a pixel unit of a solid-state imaging device according to a second embodiment;

FIG. 6 is a diagram illustrating a pixel-sharing combination in the solid-state imaging device according to the second embodiment;

FIG. 7 is a schematic configuration diagram of a wire connected to each pixel of a solid-state imaging device according to a modification; and

FIG. 8 is a schematic configuration diagram (a block diagram) of an imaging device according to a third embodiment.

### DETAILED DESCRIPTION OF THE EMBODIMENTS

Hereinafter, preferred embodiments of the present technology will be described in detail with reference to the appended drawings. Note that, in this specification and the appended drawings, structural elements that have substantially the same function and structure are denoted with the same reference numerals, and repeated explanation of these structural elements is omitted.

Hereinafter, a preferred embodiment (hereinafter referred to as an embodiment) for implementing the present technology will be described. In addition, the description will be given in the following order.

1. First Embodiment (Solid-State Imaging Device)

2. Second Embodiment (Solid-State Imaging Device)

3. Modification of Solid-State Imaging Device

4. Third Embodiment (Imaging Device)

<1. First Embodiment (Solid-State Imaging Device)>

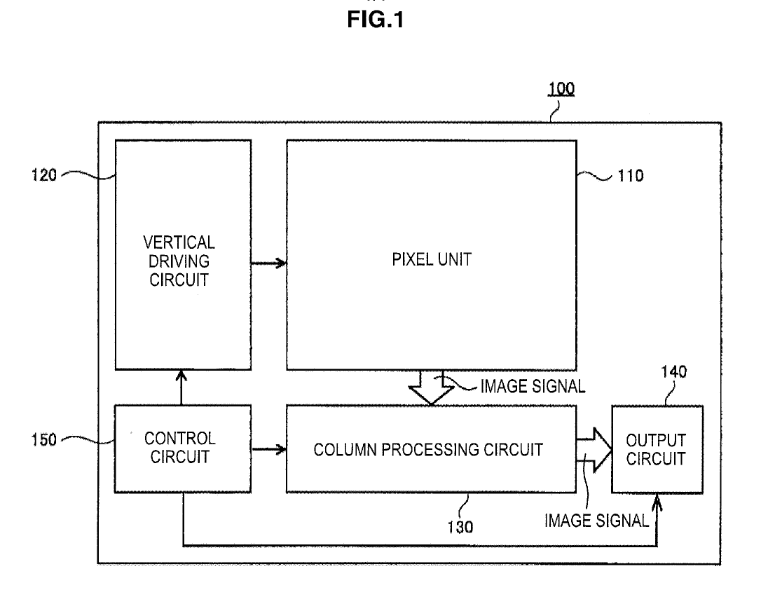

FIG. 1 is a schematic configuration diagram (a block diagram) of a solid-state imaging device according to a first embodiment.

As illustrated in FIG. 1, a solid-state imaging device 100 includes a pixel unit 110 serving as a sensor unit, a vertical driving circuit 120 configured to drive the pixel unit 110, a column processing circuit 130, an output circuit 140, and a control circuit 150.

The pixel unit 110 has a configuration in which a plurality of pixels are two-dimensionally arranged to convert an incident electromagnetic wave (light, an electric wave and the like) into charge, thereby outputting a signal corresponding to a charge amount.

The vertical driving circuit 120 is configured to drive the pixels of the pixel unit 110.

The column processing circuit 130 is configured to receive image signals from pixels of one row, obtain a difference between a signal level and a reset level, and perform analog/digital conversion and the like.

The output circuit 140 is configured to receive image signals from the column processing circuit 130 to perform gain adjustment, damage correction and the like, and output a resultant signal to an exterior.

The control circuit 150 is configured to transmit a control signal to the vertical driving circuit 120, the column processing circuit 130, and the output circuit 140, and control the operations thereof

In addition, the electromagnetic wave converted into an electric signal in the pixels of the pixel unit 110 is light such as a visible ray, an ultraviolet ray, or an infrared ray in a normal solid-state imaging device. However, in the solid-state imaging device of the present technology such as the solid-state imaging device 100 of FIG. 1, it is not specifically limited.

The solid-state imaging device of the present technology can be configured to convert various electromagnetic waves of a predetermined wavelength range, which include light such as a visible ray, an ultraviolet ray or an infrared ray, ionizing radiation, an electric wave, a microwave and the like, into electric signals.

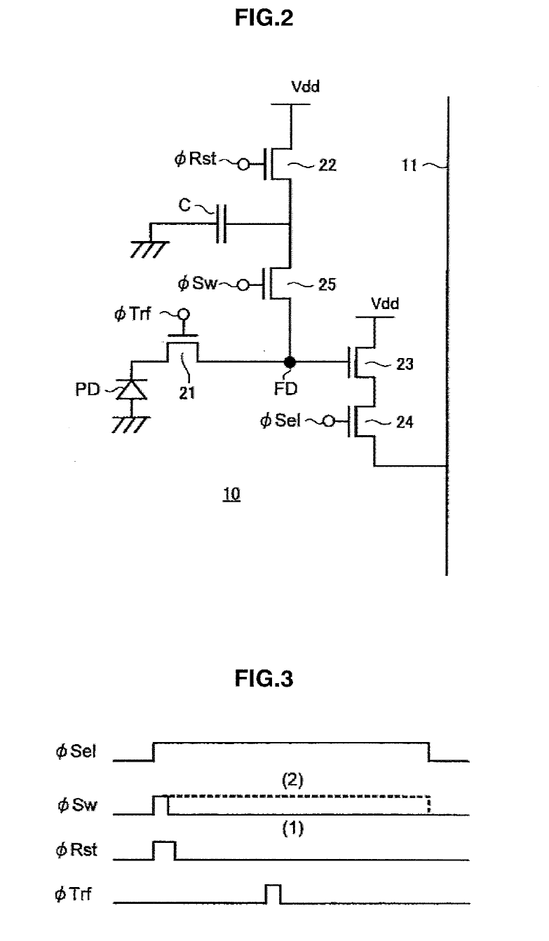

Next, FIG. 2 is a circuit configuration diagram of the pixel of the pixel unit 110 of the solid-state imaging device 100 in FIG. 1.

A pixel 10 illustrated in FIG. 2 includes the same circuit elements as in a conventional pixel having four transistors. That is, the pixel 10 includes a photodiode PD, a transmission transistor 21, a floating diffusion FD, a reset transistor 22, an amplification transistor 23, and a selection transistor 24.

The pixel 10 illustrated in FIG. 2 further includes a capacitor C and a switch transistor 25 between the floating diffusion FD and the reset transistor 22.

The photodiode PD, which is a photoelectric conversion element, is connected to the floating diffusion FD through the transmission transistor 21.

The floating diffusion FD is connected to a gate of the amplification transistor 23.

One of a source and a drain of the amplification transistor 23 is connected to a power supply wire Vdd, and the other thereof is connected to one of a source and a drain of the selection transistor 24.

The other of the source and the drain of the selection transistor 24 is connected to a vertical signal line 11.

The floating diffusion FD and the capacitor C are connected to each other through the switch transistor 25. That is, one of a source and a drain of the switch transistor 25 is connected to the floating diffusion FD, and the other thereof is connected to the capacitor C and one of a source and a drain of the reset transistor 22.

The other of the source and the drain of the reset transistor 22 is connected to the power supply wire Vdd.

A transmission pulse φTrf is supplied to a gate of the transmission transistor 21, a reset pulse φRst is supplied to a gate of the reset transistor 22, and a selection pulse φSel is supplied to a gate of the selection transistor 24. Furthermore, a switch pulse φSw is supplied to a gate of the switch transistor 25.

In addition, all the transistors 21 to 25 of the pixel 10 illustrated in FIG. 2 are NMOS transistors, and charge serving as a carrier is electrons.

The amplification transistor 23 generates a signal (an image signal) corresponding to a potential of the floating diffusion FD. Then, if the selection transistor 24 is turned on, the amplification transistor 23 outputs the generated signal (image signal) to the vertical signal line 11.

When the reset transistor 22 is turned on, the reset transistor 22 puts charge of the capacitor C and the floating diffusion FD to the power supply wire Vdd, thereby resetting the capacitor C and the floating diffusion FD.

The configuration of the pixel 10 has been conventionally proposed (for example, refer to Japanese Patent Application National Publication (Laid-Open) No. 2009-505498).

Next, FIG. 3 is a timing chart of a driving pulse for driving the pixel 10 of FIG. 2.

If the selection pulse φSel is turned on, a signal indicating the potential of the floating diffusion FD appears on the vertical signal line 11.

If the switch pulse φSw and the reset pulse φRst are turned on, the capacitor C and the floating diffusion FD are reset. If the reset pulse φRst is turned off, since a reset level appears on the vertical signal line 11, a column circuit takes and holds the reset level.

FIG. 3 illustrates the case (1) indicated by a solid line in which the switch pulse φSw is turned off from an on state and the case (2) indicated by a dotted line in which the switch pulse φSw maintains a turned-on state.

(1) When the switch pulse φSw is turned off from an on state, since the floating diffusion FD is separated from the capacitor C, the floating diffusion FD has a small capacity. Since the floating diffusion FD has a small capacity, the potential of the floating diffusion FD is significantly reduced with a small number of electrons, resulting in the achievement of a high gain. From this standpoint, a signal with high sensitivity is output. However, when the number of signal electrons is large, since the electrons overflow in the floating diffusion FD, it is not possible to obtain the original signal corresponding to an incident amount.

(2) When the switch pulse φSw maintains a turned-on state, since the floating diffusion FD is connected to the capacitor C, the floating diffusion FD has a large capacity. Since the floating diffusion FD has a large capacity, a low gain is achieved instead of accepting many electrons, resulting in a reduction of sensitivity.

As described above, the switch pulse φSw supplied to the switch transistor 25 is changed to change the capacity of a charge holding part, so that it is possible to change a relation (a conversion gain) between a charge amount and a signal amount.

Thereafter, if the transmission pulse φTrf is turned on, since signal electrons are transmitted from the photodiode PD to the floating diffusion FD, the potential of the floating diffusion FD is reduced. Therefore, since the potential of the vertical signal line 11 is also reduced, the column circuit takes the signal level of the vertical signal line 11 at that time, obtains and holds a difference between the signal level and the reset level previously taken, and outputs the difference at a subsequent timing.

It has been known that using the pixel with such a configuration, it is possible to achieve a high gain operation mode, a low gain operation mode, and a dynamic range expansion mode as the operation mode of the solid-state imaging device. Among these, in the dynamic range expansion mode, after a high gain signal and a low gain signal are read from the same pixel, these signals read twice are combined with each other at a subsequent stage.

However, in the dynamic range expansion mode, since the signals are read twice from the same pixel, an operation is significantly changed and a corresponding column circuit is also complicated, so that a frame rate is reduced to ½ or the size of the column circuit is doubled.

That is, in order to use the dynamic range expansion mode, a large-scale solid-state imaging device designed exclusively is necessary.

On the other hand, in the present embodiment, although there is no big difference relative to the conventional configuration in which the dynamic range is not expanded, it is possible to expand the dynamic range by the solid-state imaging device having a simple configuration.

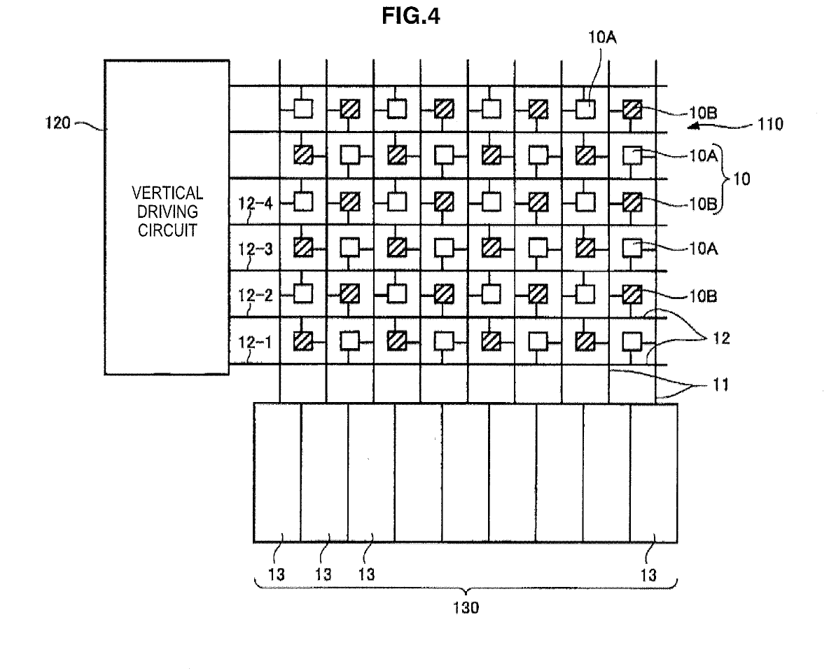

FIG. 4 is a schematic configuration diagram of a wire connected to each pixel 10 of the pixel unit 110 of the solid-state imaging device 100 in FIG. 1.

In FIG. 4, a transverse wire from the vertical driving circuit 120 is a wire (hereinafter referred to as Sw wire) 12 for driving a gate of a switch transistor sw. In addition, transverse wires from the vertical driving circuit 120 include a wire for supplying the reset pulse φRst, a wire for supplying the transmission pulse φTrf, a wire for supplying the selection pulse φSel, and the like, in addition to the Sw wire 12. However, these wires are not illustrated in FIG. 4.

A longitudinal wire is the vertical signal line 11 illustrated in FIG. 2. Each vertical signal line 11 is arranged among pixels of each column, and is connected to a corresponding processing circuit 13 of the column processing circuit 130.

In the pixel unit 110, the pixels 10 are two-dimensionally arranged in a matrix form.

In the pixels 10, pixels 10A indicated by a white rectangle and pixels 10B indicated by a rectangle with oblique lines are alternately arranged in a checked pattern in each row and each column.

The Sw wire 12 is indicated with numerals 12-1, 12-2, 12-3, 12-4, . . . from below in FIG. 4, the Sw wire 12 is arranged between pixels of each row.

The respective Sw wires 12 (12-1, 12-2, 12-3, 12-4, . . . ) are connected to the pixels 10 of different rows in odd-numbered columns and even-numbered columns That is, the Sw wire 12 is connected to the pixel 10 of a row below the Sw wire 12 in the odd-numbered column from the left, and is connected to the pixel 10 of a row above the Sw wire 12 in the even-numbered column That is, in the pixels of each row, odd-numbered pixels and even-numbered pixels from the left are alternately connected to different Sw wires 12.

Moreover, only the pixels 10A indicated by a white rectangle are connected to the odd-numbered Sw wires 12-1, 12-3, . . . from below, and only the pixels 10B indicated by a rectangle with oblique lines are connected to the even-numbered Sw wires 12-2, 12-4, . . . from below.

In addition, the wires for pixel driving, other than the Sw wire 12, may be alternately connected to pixels of a lower row and pixels of an upper row in each column, similarly to the Sw wire 12, or may be simply connected to pixels of the same row in a horizontal line, differently from the Sw wire 12.

The respective vertical signal lines 11 are connected to the pixels 10 of different columns in odd-numbered rows and even-numbered rows. That is, the vertical signal lines 11 are connected to the pixels 10 of left columns of the vertical signal lines 11 in the odd-numbered rows from below, and are connected to the pixels 10 of right columns of the vertical signal lines 11 in the even-numbered rows from below.

Moreover, the pixels 10A indicated by a white rectangle are connected to the odd-numbered vertical signal lines 11 from the left, and the pixels 10B indicated by a rectangle with oblique lines are connected to the even-numbered vertical signal lines 11 from the left.

In the configuration illustrated in FIG. 2 to FIG. 4, the following three operations are possible. (1) All the Sw wires 12 are allowed to be at a Low level (the off state of FIG. 3), so that all pixels are read with a high gain. (2) All the Sw wires 12 are allowed to be at a High level (the on state of FIG. 3), so that all pixels are read with a low gain. (3) The odd-numbered Sw wires 12-1, 12-3, . . . are fixed to a High level (the on state of FIG. 3), and the even-numbered Sw wires 12-2, 12-4, . . . are fixed to a Low level (the off state of FIG. 3). In this way, the pixels 10A indicated by a white rectangle are read with a low gain, and the pixels 10B indicated by a rectangle with oblique lines are read with a high gain.

In the present embodiment, among these operations, the dynamic range is expanded through the operation (3).

In the operation (3), sensitivity is allowed to differ between adjacent pixels. However, the use efficiency of light is not changed using the size of an opening or transmittance and a storage time is not allowed to differ as in the conventionally proposed configuration in which sensitivity is allowed to differ between adjacent pixels.

A configuration of a part for converting an electromagnetic wave into charge, that is, the configuration of the photodiode PD or the transmission transistor 21, is the same in adjacent pixels. In this way, in the adjacent pixels, the storage time is the same and the amount of obtained charge is also approximately the same.

Furthermore, in the operation (3), the capacity of a part for holding the charge read from the photodiode PD is allowed to differ between the adjacent pixels, so that the capacity is large (FD+C) or small (only FD). In this way, even when a gain is changed in the same pixel and reading is not performed twice, signals with different gains are obtained in the adjacent pixels through one-time reading in each pixel.

Normally, if the operation (1) or the operation (2) is used according to the brightness of an object, it is possible to capture an image with full resolution. Furthermore, only when emphasizing the size of the dynamic range, is it possible to use the operation (3).

In the operation (3), since the storage time in the photodiode PD is the same in each pixel, color shift and the like do not occur at an edge due to shake or the movement of an object.

Furthermore, since a signal is not read twice from the same pixel, a large-scale solid-state imaging device designed exclusively is not necessary either. It is also easy to switch the operations (1) to (3) according to a photographing scene.

In pixels of each row, odd-numbered pixels and even-numbered pixels are alternately connected to different Sw wires 12 (for example, 12-1 and 12-2), so that pixels with a low gain and pixels with a high gain are provided with the same vertical and horizontal resolution.

Furthermore, in pixels of each column, odd-numbered pixels and even-numbered pixels are alternately connected to different vertical signal lines 11. In this way, since signals with a low gain or signals with a high gain are not provided to the processing circuits 13 of the column processing circuit 130 in each row and signals with the same level are provided each time, optimization is easy.

According to the solid-state imaging device 100 of the above-mentioned embodiment, in the pixels 10A and the pixels 10B adjacent to each other, the configurations of the photodiode PD for converting an electromagnetic wave into charge and the transmission transistor 21 are the same, but it is possible to allow a conversion gain to differ.

Furthermore, the gate of the switch transistor 25 is turned on and off, so that it is possible to change the capacity of the charge holding part between the large capacity (FD+C) and the small capacity (only FD).

In this way, it is possible to obtain a signal with high conversion gain and high sensitivity and a signal with low conversion gain and low sensitivity from the adjacent pixels, so that it is possible to expand the dynamic range.

Furthermore, the capacity of the charge holding part is changed to change the conversion gain, so that no difference occurs in the conversion gain in the operations (1) and (2) and the conversion gain differs in the operation (3) in the adjacent pixels.

In addition, in the pixels 10A and the pixels 10B adjacent to each other, since the configurations of the photodiode PD for converting the electromagnetic wave into the charge and the transmission transistor 21 are the same, a charge storage time is the same. Even when there is shake or movement of an object, it is possible to prevent the occurrence of color shift. Moreover, since charge obtained in a pixel with a low conversion gain is the same as in a pixel with a high conversion gain, a sufficient amount of charge is obtained.

Furthermore, according to the present embodiment, reading is not performed twice after a gain is changed in the same pixel, but signals with different gains can be obtained in adjacent pixels through one-time reading in each pixel.

In this way, a large-scale solid-state imaging device designed exclusively is not necessary, there is no big difference relative to the conventional configuration in which the dynamic range is not expanded, and it is possible to expand the dynamic range by the solid-state imaging device 100 having a simple configuration.

<2. Second Embodiment (Solid-State Imaging Device)>

Next, a solid-state imaging device of a second embodiment will be described.

In the second embodiment, a schematic configuration of the solid-state imaging device is the same as the schematic configuration of the solid-state imaging device 100 of the first embodiment illustrated in FIG. 1. However, in the pixel unit 110, an amplification transistor, a switch transistor and the like are shared in two pixels.

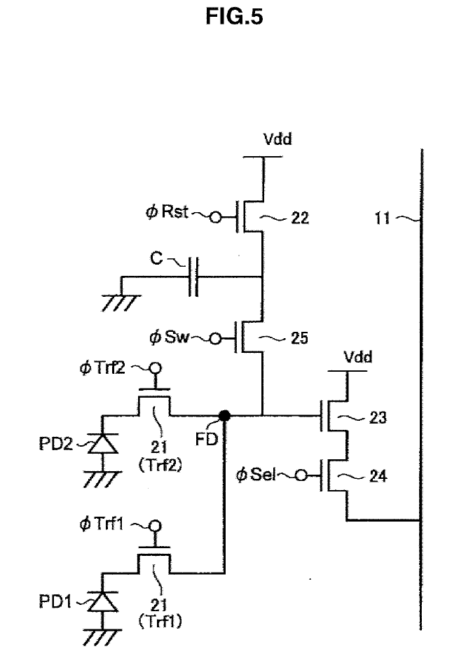

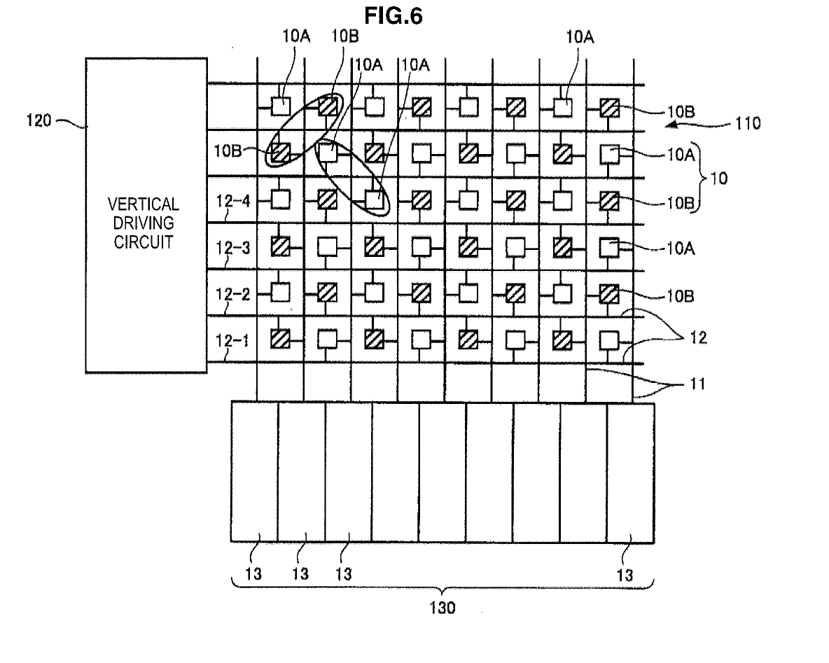

FIG. 5 is a circuit configuration diagram of a pixel of the pixel unit 110 of the solid-state imaging device according to the second embodiment.

In two pixels, photodiodes PD1 and PD2 and transmission transistors 21 (Trf1 and Trf2) are arranged in each pixel, but transistors 22, 23, 24, and 25 and the capacitor C next to the floating diffusion FD are shared.

In the conventionally proposed configuration in which the amplification transistor and the like are shared in a plurality of pixels, the amplification transistor and the like are shared in pixels of the same row or the same column, or four pixels of two rows and two columns.

On the other hand, in the present embodiment, since a gain is changed according to the size of a part for holding charge read from adjacent pixels similarly to the first embodiment, a combination of pixels sharing the amplification transistor and the like is different from the conventional combination.

FIG. 6 is a diagram illustrating a pixel-sharing combination in the solid-state imaging device according to the present embodiment. FIG. 6 additionally illustrates a part of a pixel-sharing combination with respect to the same configuration as the schematic configuration of the wire of the first embodiment illustrated in FIG. 4.

FIG. 6 illustrates a combination of sharing a pixel 10B of a 5^{th} row from below in a first column from the left and a pixel 10B of a 6^{th} row in a second column, which are obliquely adjacent to each other from the left upper quadrant to the right lower quadrant. Furthermore, FIG. 6 illustrates a combination of sharing a pixel 10A of the 5^{th} row in the second column and a pixel 10A of a 4^{th} row in a third column, which are obliquely adjacent to each other from the left lower quadrant to the right upper quadrant. For other pixels, a combination of sharing pixels 10A and pixels 10B obliquely adjacent to each other is established.

In addition, if the combinations are established as described above, pixels of the endmost row or the endmost column of the pixel unit 110 remain. However, these pixels are dummy pixels which operate but output signals of which are not used.

According to the above-mentioned present embodiment, similarly to the previous embodiment, in the pixel A and the pixel 10B adjacent to each other, the configurations of the photodiode PD for converting an electromagnetic wave into charge and the transmission transistor 21 are the same, but it is possible to allow a conversion gain to differ.

Furthermore, the gate of the switch transistor 25 is turned on and off, so that it is possible to change the capacity of the charge holding part between the large capacity (FD+C) and the small capacity (only FD).

Consequently, similarly to the previous embodiment, it is possible to expand the dynamic range, and it is possible to prevent the occurrence of color shift even when there is the movement of an object. Furthermore, since charge obtained in a pixel with a low conversion gain is the same as in a pixel with a high conversion gain, a sufficient amount of charge is obtained. Moreover, a large-scale solid-state imaging device designed exclusively is not necessary, there is no big difference relative to the conventional configuration in which the dynamic range is not expanded, and it is possible to expand the dynamic range by the solid-state imaging device having a simple configuration.

According to the above-mentioned embodiment, the FD, the amplification transistor 22 and the like are shared in two pixels. However, they may be shared in four pixels.

When they are shared in four pixels, it is preferable that they be shared in (2×2) pixels of the same two columns

For example, in FIG. 6, the FD, the amplification transistor 22 and the like are shared in the total four pixels, that is, two pixels 10A of the 5^{th} row in the second column and the 4^{th} row in the third column, which are surrounded by a line, and two pixels 10A of a 3^{rd} row in the second column and the 2^{nd} row in the third column, which are in the same two columns.

For the pixels B, the FD, the amplification transistor 22 and the like are shared in the pixels B which are in the same two columns.

<3. Modification of Solid-State Imaging Device >

According to the above-mentioned embodiments, only the pixel 10A or only the pixel 10B is connected to the same vertical signal line 11, and the vertical signal lines 11 are connected to the pixels 10 of different columns in odd-numbered rows and even-numbered rows.

On the other hand, it may be possible to employ a configuration in which the vertical signal lines 11 are connected to the pixels 10 of the same column

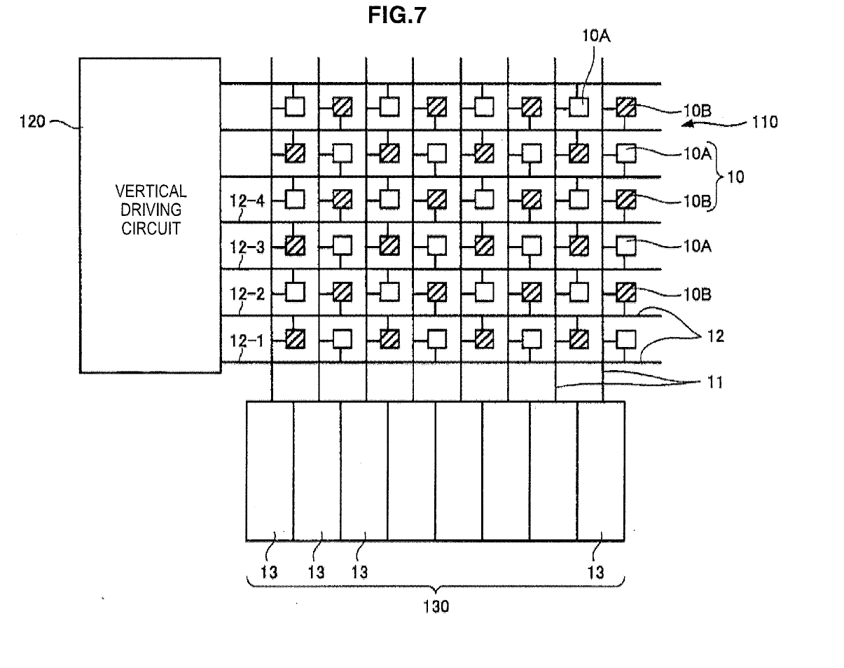

In this case, the circuit configuration of the pixels 10A and 10B of the pixel unit 110 is illustrated in FIG. 7.

As illustrated in FIG. 7, the vertical signal lines 11 are connected to pixels of the same column, and are connected to the pixels 10A and 10B.

In FIG. 7, a connection between the Sw wire 12 and the pixels 10A and 10B is the same as in FIG. 4. That is, only the pixels 10A are connected to the odd-numbered Sw wires 12-1 and 12-3 and only the pixels 10B are connected to the even-numbered Sw wires 12-2 and 12-4. In this way, similarly to the above-mentioned embodiments, a gain is allowed to differ between adjacent pixels, so that it is possible to expand the dynamic range.

When the vertical signal lines 11 are alternately connected to the pixels of the right columns and the pixels of the left columns as illustrated in FIG. 4, it is advantageous in that optimization is easy, as compared with the case of FIG. 7.

This is because, when the vertical signal lines 11 are connected to the pixels as illustrated in FIG. 4, signals input to the processing circuits 13 of respective rows of the column processing circuit 130 are only signals with a low gain or only signals with a high gain, and signals of the same level are input to the processing circuits 13 each time.

According to the above-mentioned embodiments, the switch transistor 25 is turned on and off, so that it is possible to change the conversion gain of the pixel 10.

On the other hand, it may also be possible to fix the conversion gain of each pixel. For example, it is sufficient if the capacitor C is connected between the floating diffusion FD and the reset transistor of every one pixel without providing the switch transistor and the Sw wire.

In this configuration, a high resolution operation and a dynamic range expansion operation is not switched. However, it is possible to expand the dynamic range using a simple configuration without a change in the storage time of a pixel.

According to the above-mentioned embodiments, the capacity of the floating diffusion FD is changed to change the conversion gain.

On the other hand, it may also be possible to change the conversion gain regardless of a change in the capacity.

For example, since the column processing circuit 130 is provided with a gain stage as a circuit for applying a gain before AD conversion, the gain state is allowed to differ in the pixel 10A and the pixel 10B, that is, the gain state is changed in each column, so that it is possible to change the gain.

According to the above-mentioned embodiments, the pixels 10 (10A and 10B) are arranged in the matrix form, the vertical signal line 11 extends in the longitudinal direction, and the Sw wire 12 extends in the transverse direction.

However, the present technology is not limited to the configuration in which the pixels are arranged in the matrix form. That is, the present technology can also be applied to other configurations in which the pixels are two-dimensionally arranged.

For example, the present technology can also be applied to a configuration in which wires are obliquely arranged, a configuration in which the shape of pixels is not a rectangle but a honeycomb and the wires are bent from side to side along the pixels, and the like.

The present technology can also be applied to a stack configuration in which a photoelectric conversion unit and a logic unit are stacked. The present technology can also be applied in the same manner if a circuit configuration is the same as that of a normal solid-state imaging device.

If there are other configurations in which a gain is allowed to differ in each pixel, the same operation and effect can be achieved.

<4. Third Embodiment (Imaging Device)>

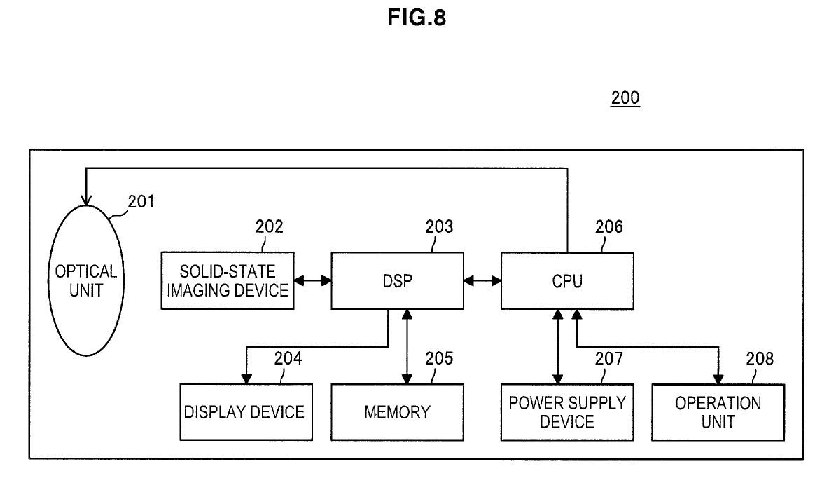

FIG. 8 is a schematic configuration diagram (a block diagram) of an imaging device according to a third embodiment.

As illustrated in FIG. 8, an imaging device 200 includes an optical unit 201 having a lens group and the like, a solid-state imaging device 202, a DSP circuit 203 serving as a camera signal processing circuit, a display device 204, a memory 205, a CPU 206, a power supply device 207, and an operation unit 208.

The optical unit 201 is configured to receive an electromagnetic wave such as light incident from an object, and form an image on an imaging plane of the solid-state imaging device 202.

The solid-state imaging device 202 is configured to convert the amount of the electromagnetic wave such as the light imaged on the imaging plane by the optical unit 201 into an electric signal in units of pixels, and output the electric signal as a pixel signal.

As the solid-state imaging device 202, the solid-state imaging device according to the present technology, such as the solid-state imaging devices of the above-mentioned embodiments, is used.

The display device 204 includes a panel-type display device such as a liquid crystal display device or an organic EL (electro luminescence) display device, and displays a moving image or a still image captured by the solid-state imaging device 202.

The power supply device 207 is configured to appropriately supply various power voltages to the DSP circuit 203, the display device 204, the memory 205, and the operation unit 208 as operation voltages thereof.

The operation unit 208 is configured to output operation commands for various functions of the imaging device 200 based on an operation of a user.

It is possible for the imaging device 200 to switch the above-mentioned operation (3) by receiving the intention of a photographer from an exterior.

Furthermore, in the imaging device 200, when employing a configuration in which the DSP 203 monitors the brightness of an object, it is possible for the DSP 203 to automatically determine whether to use the operation (1), (2), or (3) according to a result of the monitoring, thereby setting the gain.

For example, when a difference in the brightness of an object is small, it is possible to automatically select the operation (1) or (2) according to the brightness. When the difference in the brightness of the object is large, it is possible to automatically select the operation (3).

Then, the solid-state imaging device 202 receives a command from the DSP 203 to transmit the command to a control circuit (for example, the control circuit 150 of the solid-state imaging device 100 of FIG. 1) of the solid-state imaging device 202. For example, the DSP 203 receives a command and performs a synthesizing process in the operation (3).

In addition, when the above-mentioned operation is switched by the intention of an imaging person, the operation unit 208 and the CPU 206 also participate in this switching operation along with the DSP 203. For external input regarding operation selection, the content of input from the operation unit 208 is transmitted to the CPU 206, and a selected operation is transmitted from the CPU 206 to the DSP 203.

In accordance with the configuration of the above-mentioned imaging device 200 according to the present embodiment, the solid-state imaging device according to the present technology, such as the solid-state imaging devices of the above-mentioned embodiments, is used as the solid-state imaging device 202, so that it is possible to expand the dynamic range without color shift. Furthermore, since charge obtained in a pixel with a low conversion gain is the same as in a pixel with a high conversion gain, a sufficient amount of charge is obtained. Moreover, a large-scale solid-state imaging device designed exclusively is not necessary, there is no big difference relative to the conventional configuration in which the dynamic range is not expanded, and it is possible to expand the dynamic range by the solid-state imaging device 202 having a simple configuration.

Furthermore, in accordance with the configuration of the imaging device 200 according to the present embodiment, it is possible to automatically select a mode in which a normal image with full resolution is output and the dynamic range expansion mode according to the state of an object, or to select the two modes by the intention of an imaging person.

In the present technology, the configuration of the imaging device is not limited to the configuration illustrated in FIG. 8. For example, if there are configurations in which the solid-state imaging device according to the present technology is used, the present technology may employ configurations other than the configuration illustrated in FIG. 8.

The present technology may also be configured as below.

(1) A solid-state imaging device comprising:
pixels configured to convert an electromagnetic wave into charge and output a signal corresponding a charge amount; and
a pixel unit in which the pixels are two-dimensionally arranged, and a configuration of a part for converting the electromagnetic wave into the charge is the same in adjacent pixels, but a relation between the charge amount and a signal amount is allowed to differ between the adjacent pixels.

(2) The solid-state imaging device according to (1), wherein a conversion gain, which is the relation between the charge amount and the signal amount, is switched in each pixel, and a state with no difference in the conversion gain and a state with different conversion gains are switched in the adjacent pixels.

(3) The solid-state imaging device according to (2), wherein a capacity of a part for holding the charge of the pixel is changed to change the conversion gain of the pixel.

(4) The solid-state imaging device according to (3), wherein the pixel unit includes the pixels arranged in a matrix form, and the solid-state imaging device further comprises:
a switch wire provided corresponding to each pixel row; and
a switch transistor disposed in each pixel and connected to the switch wire to change the capacity.

(5) The solid-state imaging device according to (4), wherein, in the pixels of each row, odd-numbered pixels and even-numbered pixels are alternately connected to different switch wires.

(6) An imaging device comprising:
the solid-state imaging device according to any one of (1) to (5),
an optical unit configured to guide incident light to the solid-state imaging device; and
a signal processing circuit configured to process an output signal of the solid-state imaging device.

(7) The imaging device according to (6), wherein the relation between the charge amount and the signal amount in the pixels of the solid-state imaging device is changed by external input.

The present technology is not limited to the above-mentioned embodiments. For example, various configurations can be achieved within the scope of the present technology.

The present technology contains subject matter related to that disclosed in Japanese Priority Patent Application JP 2011-168020 filed in the Japan Patent Office on Aug. 1, 2011, the entire content of which is hereby incorporated by reference.

What is claimed is:

1. A solid-state imaging device comprising:
pixels configured to convert an electromagnetic wave into charge and output a signal corresponding a charge amount; and
a pixel unit in which the pixels are two-dimensionally arranged, and a configuration of a part for converting the electromagnetic wave into the charge is the same in adjacent pixels, but a relation between the charge amount and a signal amount is allowed to differ between the adjacent pixels.

2. The solid-state imaging device according to claim 1, wherein a conversion gain, which is the relation between the charge amount and the signal amount, is switched in each pixel, and a state with no difference in the conversion gain and a state with different conversion gains are switched in the adjacent pixels.

3. The solid-state imaging device according to claim 2, wherein a capacity of a part for holding the charge of the pixel is changed to change the conversion gain of the pixel.

4. The solid-state imaging device according to claim 3, wherein the pixel unit includes the pixels arranged in a matrix form, and the solid-state imaging device further comprises:
a switch wire provided corresponding to each pixel row; and
a switch transistor disposed in each pixel and connected to the switch wire to change the capacity.

5. The solid-state imaging device according to claim 4, wherein, in the pixels of each row, odd-numbered pixels and even-numbered pixels are alternately connected to different switch wires.

6. An imaging device comprising:
a solid-state imaging device including pixels configured to convert an electromagnetic wave into charge and output a signal corresponding a charge amount, and a pixel unit in which the pixels are two-dimensionally arranged, and a configuration of a part for converting the electromagnetic wave into the charge is the same in adjacent pixels, but a relation between the charge amount and a signal amount is allowed to differ between the adjacent pixels;
an optical unit configured to guide incident light to the solid-state imaging device; and
a signal processing circuit configured to process an output signal of the solid-state imaging device.

7. The imaging device according to claim 6, wherein the relation between the charge amount and the signal amount in the pixels of the solid-state imaging device is changed by external input.
